(19) United States
(12) Patent Application Publication
(10) Pub. No.: US 2024/0188533 A1
(43) Pub. Date: Jun. 13, 2024

(54) CAT FEEDING STATION

(71) Applicant: Dillon Deaner, Morrisville, NY (US)

(72) Inventor: Dillon Deaner, Morrisville, NY (US)

(21) Appl. No.: 18/076,769

(22) Filed: Dec. 7, 2022

(51) Int. Cl. A01K 1/03; A01K 5/01; F16B 1/00

(52) U.S. Cl. CPC A01K 1/033; A01K 5/0114; F16B 1/00; F16B 2001/0035

(57) ABSTRACT

A cat feeding station includes first and second floors surrounded by sidewalls and a roof. An access opening for a cat is provided in the sidewall and a second access opening is provided through the second floor to give a cat access to the second floor. A hatch (covered by a door) is formed through the roof and provides access to the second floor for the pet owner to place a bowl of food/water through and set onto the second floor.

### CROSS-REFERENCE TO RELATED APPLICATION

N/A

### FIELD OF THE INVENTION

The present disclosure is directed generally to cat feeders.

### BACKGROUND

Cats and dogs are often fed out of bowls placed on the floor in a designated area that the pet becomes accustomed to understanding as the location where it can eat. Households with cats and dogs or cats and other animals often experience the dog or other animal eating the cat's food when left in a bowl on the floor, thus leaving the cat without any food in its dish when it decides it would like to eat.

Accordingly, there is a need in the art for a cat feeding station that prevents dogs or other animals from accessing and eating the cat's food.

### SUMMARY

The present disclosure is directed to cat feeding stations.

According to an aspect is a cat feeding station, comprising a housing having a first floor and a second floor that extends in vertically spaced, parallel relation above the first floor, sidewalls that extend around the first and second floors, and a roof that is positioned atop and in contacting relation to the sidewalls and in vertically spaced relation above the second floor; wherein, the sidewalls include a first cutout region of predetermined dimensions that provides interior access to the first floor; wherein the second floor includes a second cutout region formed therethrough in a predetermined location and being of predetermined dimensions and that provides access to the second floor from the first floor; wherein, the roof includes a hatch formed therethrough in a predetermined location that is not vertically aligned with the second cutout region and that provides access to the second floor through the roof; whereby, a user can place cat food on the second floor via the hatch and a cat can access the food by entering the station through the first cutout region and accessing the second floor through the second cutout region.

According to an embodiment, the housing is linear in shape.

According to an embodiment, the housing is L-shaped.

According to an embodiment, the sidewalls further include a third cutout region of predetermined dimensions that provides interior access to the first floor; the second floor further includes a fourth cutout region formed therethrough in a predetermined location and being of predetermined dimensions and that provides access to the second floor from the first floor; the roof further includes a second hatch formed therethrough in a predetermined location that is not vertically aligned with the second or fourth cutout regions and that provides access to the second floor through the roof; whereby, a user can place cat food on the second floor via the hatch and second hatch and a cat can access the food by entering the station through the first or third cutout regions and accessing the second floor through the second or fourth cutout regions.

According to an embodiment, the cat feeding station further comprises at least one feed bowl that is oblong in shape.

According to an embodiment, the cat feeding station further comprises at least one feed bowl having magnetic properties.

These and other aspects of the invention will be apparent from the embodiments described below.

### BRIEF DESCRIPTION OF THE DRAWINGS

The present invention will be more fully understood and appreciated by reading the following Detailed Description in conjunction with the accompanying drawings, in which:

FIG. 1 is a perspective view of a linear cat feeding station, in accordance with an embodiment.

FIG. 2 is a partial side elevation view of an L-shaped cat feeding station, in accordance with an embodiment.

FIG. 3 is an upper perspective view of a L-shaped cat feeding station, in accordance with an embodiment.

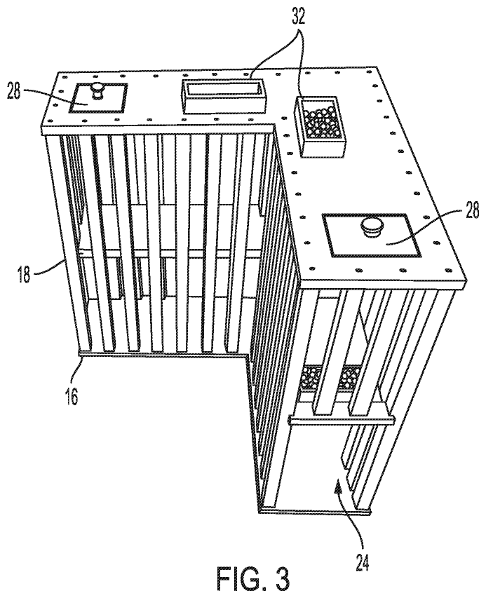

FIG. 4 is a partial side elevation view of an L-shaped cat feeding station, in accordance with an embodiment.

FIG. 5 is an upper perspective view of a liner and a L-shaped cat feeding station, in accordance with an embodiment.

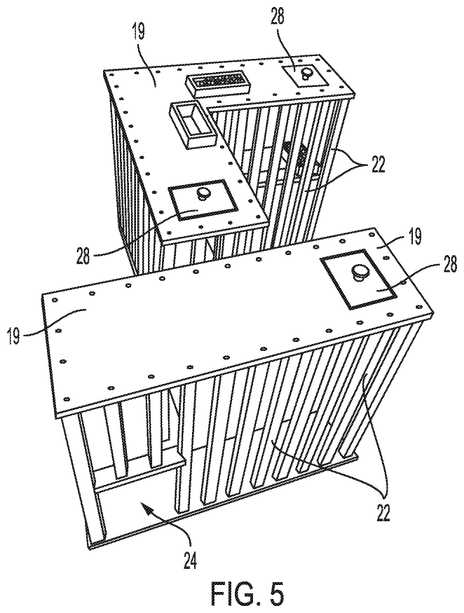

FIG. 6 is a cross-sectional view taken along section line 6-6 of FIG. 1.

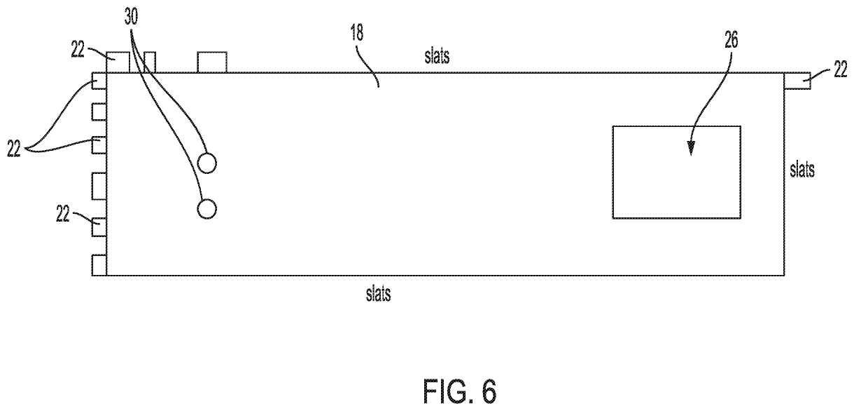

### DETAILED DESCRIPTION OF EMBODIMENTS

The present disclosure describes a cat feeding station.

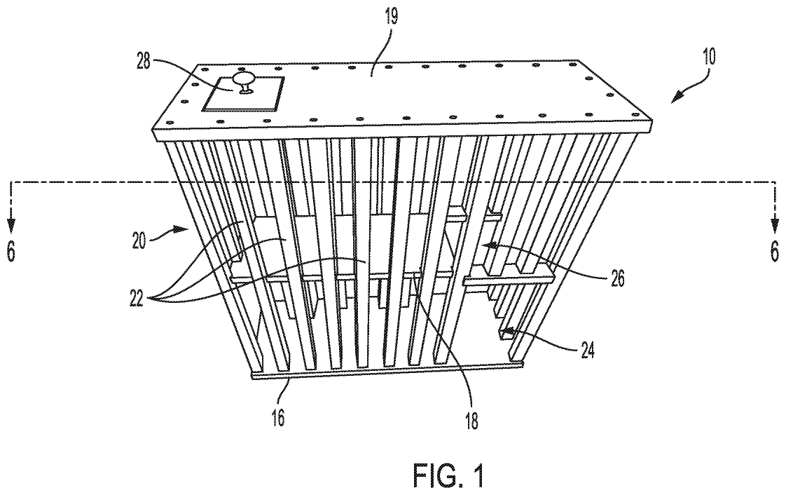

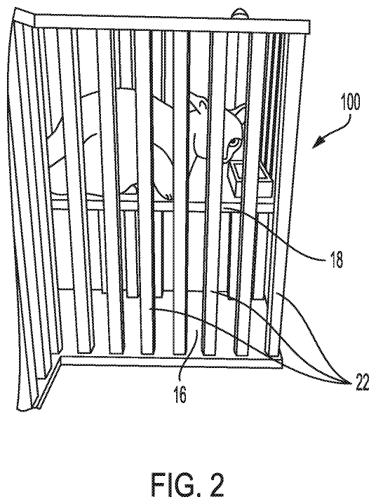

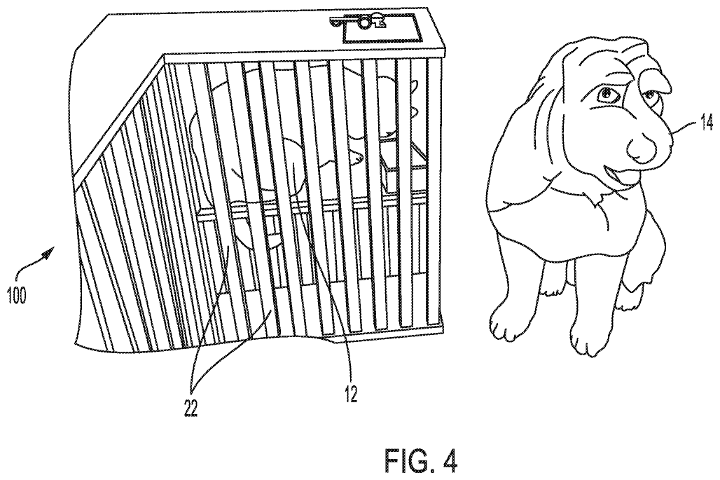

Referring to FIG. 1, in one embodiment, is a linear cat feeding station 10 designed to permit a cat 12 to feed whenever it desires without another animal 14 (see FIG. 4) accessing and eating the food. Referring to FIG. 2, in another embodiment, is a L-shaped cat feeding station 100 which for all functional purposes is identical to cat feeding station 10, just providing for two feeding areas instead of one. The features of feeding stations 10 and 100 will be referred to using common reference numerals for like parts.

Feeding station 10 (100) includes a ground floor 16, a second floor 18 vertically spaced in parallel relation above the ground floor 16, sidewalls 20 comprised of laterally spaced slats 22 surrounding the ground floor 16 and second floor 18, and a roof 19 that attaches to the top of sidewalls 20/slats 22 and which extends in spaced relation above second floor 18, preferably parallel spaced relation.

A cut-out 24 is formed in one sidewall 20 to provide access to ground floor 16 (a second cut-out is formed in the L-shaped feeder 100). The dimensions of cut-out 24 is suitable for allowing passage of a cat therethrough but too small for larger animals, preferably about 6.5 to 7.5 inches square. Once cat enters through cut-out 24, the cat may then hop through a second cut-out 26 formed through second floor 18 and which thus provides access to the second floor by way of the cat hopping up and through the cut-out (there is a second cut-out formed through the second floor in the L-shaped feeder 100). This cut-out 26 is also about 6.7 to 7.5 inches square.

A door 28 is provided on roof 19 and when opened provides access to the second floor 18 via a hatch. Door 28/hatch is positioned is non-vertically aligned position, preferably on the opposite side of second floor, from cut-out 26. A pet owner may open door 28 and place a bowl of food/water on second floor 18 which the cat may then access through its entry onto second floor 18 through cut-outs 24 and 26. L-shaped feeder 100 includes two doors, one on each end of each leg of the L-shaped, thus providing two spaces to place a cat bowl. The hatch to which door 28 provides access is about 3.5×4.5 inches.

An additional aspect are magnets 30 incorporated into the second floor 18 in the area where feed bowls are to be placed, and then magnets (and/or metal material) incorporated into feed bowls 32 to permit secure placement of the feed bowls on the second floor, making it difficult for the cat to move the feed bowl (and perhaps pushing it through cut-out 26 and making it fall to the first floor). Further, specially shaped feed bowls 30 that are oblong in shape (e.g., rectangular) will provide a bowl that is more difficult for a cat to push through the feed station.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A cat feeding station, comprising:
a. a housing having a first floor and a second floor that extends in vertically spaced, parallel relation above the first floor, sidewalls that extend around the first and second floors, and a roof that is positioned atop and in contacting relation to the sidewalls and in vertically spaced relation above the second floor;
b. wherein, the sidewalls include a first cutout region of predetermined dimensions that provides interior access to the first floor;
c. wherein, the second floor includes a second cutout region formed therethrough in a predetermined location and being of predetermined dimensions and that provides access to the second floor from the first floor;
d. wherein, the roof includes a hatch formed therethrough in a predetermined location that is not vertically aligned with the second cutout region and that provides access to the second floor through the roof;
e. whereby, a user can place cat food on the second floor via the hatch and a cat can access the food by entering the station through the first cutout region and accessing the second floor through the second cutout region.

2. The cat feeding station according to claim 1, wherein the housing is linear in shape.

3. The cat feeding station according to claim 1, wherein the housing is L-shaped.

4. The cat feeding station according to claim 2:
a. wherein, the sidewalls further include a third cutout region of predetermined dimensions that provides interior access to the first floor;
b. wherein, the second floor further includes a fourth cutout region formed therethrough in a predetermined location and being of predetermined dimensions and that provides access to the second floor from the first floor;
c. wherein, the roof further includes a second hatch formed therethrough in a predetermined location that is not vertically aligned with the second or fourth cutout regions and that provides access to the second floor through the roof;
d. whereby, a user can place cat food on the second floor via the hatch and second hatch and a cat can access the food by entering the station through the first or third cutout regions and accessing the second floor through the second or fourth cutout regions.

5. The cat feeding station according to claim 1, wherein at least one magnet is mounted to the second floor in an area where a feed bowl is to be placed.

6. The cat feeding station according to claim 1, further comprising at least one feed bowl that is oblong in shape.

7. The cat feeding station according to claim 1, further comprising at least one feed bowl having magnetic properties.
